(19) United States
(12) Patent Application Publication
(10) Pub. No.: US 2003/0154181 A1
(43) Pub. Date: Aug. 14, 2003

(54) Document clustering with cluster refinement and model selection capabilities

(75) Inventors: Xin Liu, Fremont, CA (US); Yihong Gong, Sunnyvale, CA (US); Wei Xu, San Jose, CA (US)

Correspondence Address: SUGHRUE MION, PLLC, 2100 PENNSYLVANIA AVENUE, N.W., WASHINGTON, DC, 20037, US

(73) Assignee: NEC USA, Inc.

(21) Appl. No.: 10/144,030

(22) Filed: May 14, 2002

Related U.S. Application Data
(60) Provisional application No. 60/350,948, filed on Jan. 25, 2002.

(51) Int. Cl. G06F 7/00

(52) U.S. Cl. 707/1

(57) ABSTRACT

A document partitioning (flat clustering) method clusters documents with high accuracy and accurately estimates the number of clusters in the document corpus (i.e. provides a model selection capability). To accurately cluster the given document corpus, a richer feature set is employed to represent each document, and the Gaussian Mixture Model (GMM) together with the Expectation-Maximization (EM) algorithm is used to conduct an initial document clustering. From this initial result, a set of discriminative features is identified for each cluster, and the initially obtained document clusters are refined by voting on the cluster label for each document using this discriminative feature set. This self refinement process of discriminative feature identification and cluster label voting is iteratively applied until the convergence of document clusters. Furthermore, a model selection capability is achieved by introducing randomness in the cluster initialization stage, and then discovering a value C for the number of clusters N by which running the document clustering process for a fixed number of times yields sufficiently similar results.

### RELATED APPLICATIONS

This Application claims priority from co-pending U.S. Provisional Application Serial No. 60/350,948, filed Jan. 25, 2002, which is incorporated in its entirety by reference.

### BACKGROUND OF THE INVENTION

1. Field of the Invention

This invention relates to information retrieval methods and, more specifically, to a method for document clustering with cluster refinement and model selection capabilities.

2. Background and Related Art

1. References

The following papers provide useful background information, for which they are incorporated herein by reference in their entirety, and are selectively referred to in the remainder of the disclosure by their accompanying reference numbers in angled brackets (i.e. <3> for the third numbered paper by L. Baker et al.):

<1> Tagged Brown Corpus: http://www.hit.uib.no/icame/brown/bcm.html, 1979.

<2> NIST Topic Detection and Tracking Corpus: http://www.nist.gov/speech/tests/tdt/tdt98/index.htm, 1998.

<3> L. Baker and A. McCallum. Distributional Clustering of Words for Text Classification. In Proceedings of ACM SIGIR, 1998.

<4> W. Croft. Clustering Large Files of Documents using the Single-link Method. Journal of the American Society of Information Science, 28:341-344, 1977.

<5> D. R. Cutting, D. R. Karger, J. O. Pederson, and J. W. Tukey. Scatter/Gather: A Cluster-based Approach to Browsing Large Document Collections. In Proceedings of ACM/SIGIR, 1992.

<6> R. O. Duda, P. E. Hart, and D. G. Stork. Pattern Classification, second edition. Wiley, New York, 2000.

<7> W. A. Gale and K. W. Church. Identifying Word Correspondences in Parallel Texts. In Proceedings of the Speech and Natural Language Work Shop, page 152, Pacific Grove, Calif., 1991.

<8> M. Goldszmidt and M. Sahami. A Probabilistic Approach to Full-text Document Clustering. In SRI Technical Report ITAD-433-MS-98-044, 1997.

<9> T. Hofmann. The Cluster-abstraction Model: Unsupervised Learning of Topic Hierarchies from Text Data. In Proceedings of IJCAI-99, 1999.

<10> D. Pelleg and A. Moore. X-means: Extending K-means with Efficient Estimation of the Number of Clusters. In Proceedings of the Seventeenth International Conference on Machine Learning (ICML2000), June 2000.

<11> F. Pereira, N. Tishby, and L. Lee. Distributional Clustering of English Words. In Proceedings of the Association for Computational Linguistics, pp. 183-190, 1993.

<12> J. Platt. Sequential Minimal Optimization: A Fast Algorithm for Training Support Vector Machines. Technical report 98-14, Microsoft research. http://www.research.microsoft.com/jplatt/smo.html, 1998.

<13> P. Willett. Recent Trends in Hierarchical Document Clustering: A Critical Review. nformaton Processing & Management, 24(5):577-597, 1988.

<14> P. Willett. Document Clustering using an Inverted File Approach. Journal of Information Science, 2:223-231, 1990.

2. Related Art

Traditional text search engines accomplish document retrieval by taking a query from the user, and then returning a set of documents matching the user's query. Nowadays, as the primary users of text search engines have shifted from librarian experts to ordinary people who do not have much knowledge about information retrieval (IR) methods, and in light of the explosive growth of accessible text documents on the Internet, traditional IR techniques are becoming more and more insufficient for meeting diversified information retrieval needs, and for handling huge volumes of relevant text documents.

Traditional IR techniques suffer from numerous problems and limitations. The following examples provide some illustrative contexts in which these problems and limitations are manifested.

First, text retrieval results are sensitive to the keywords used by the user to form queries. To retrieve the documents of interest, the user must formulate the query using the keywords that appear in the documents. This is a difficult task, if not impossible, for ordinary people who are not familiar with the vocabulary of the data corpus.

Second, traditional text search engines cover only one end of the whole spectrum of information retrieval needs, which is a narrowly specified search for documents matching the user's query <5>. They are not capable of meeting the information retrieval needs from the remaining part of the spectrum in which the user has a rather broad or vague information need (e.g. what are the major international events in the year 2001), or has no well defined goals but wants to learn more about the general contents of the data corpus.

Third, with an ever-increasing number of on-line text documents available on the Internet, it has become quite common for a keyword-based text search by a traditional search engine to return hundreds, or even thousands of hits, by which the user is often overwhelmed. As a consequence, access to the desired documents has become a more difficult and arduous task than ever before.

The above problems can be lessened by clustering documents according to their topics and main contents. If the document clusters are appropriately created, each of which is assigned an informative label, then it is probable that the user can reach his/her documents of interest without having to worry about which keywords to choose to formulate a query. Also, information retrieval by browsing through a hierarchy of document clusters is more suitable for users who have a vague information need, or just want to discover the general contents of the data corpus. Moreover, document clustering may also be useful as a complement to traditional text search engines when a keyword-based search returns too many documents. When the retrieved document set consists of multiple distinguishable topics/sub-topics, which is often true, organizing these documents by topics (clusters) certainly helps the user to identify the final set of the desired documents.

Document clustering methods can be mainly categorized into two types: document partitioning (flat clustering) and hierarchical clustering. Although both types of methods have been extensively investigated for several decades, accurately clustering documents without domain-dependent background information, nor predefined document categories or a given list of topics is still a challenging task. Document partitioning methods further face the difficulty of requiring prior knowledge of the number of clusters in the given data corpus. While hierarchical clustering methods avoided this problem by organizing the document corpus into a hierarchical tree structure, clusters in each layer, however, do not necessarily correspond to a meaningful grouping of the document corpus.

Of the above two types of document clustering methods, document partitioning methods decompose a collection of documents into a given number of disjoint clusters which are optimal in terms of some predefined criteria functions. Typical methods in this category include K-Means clustering <3>, probabilistic clustering <3, 11>, Gaussian Mixture Model (GMM), etc. A common characteristic of these methods is that they all require the user to provide the number of clusters comprising the data corpus. However, in real applications, this is a rather difficult prerequisite to satisfy when given an unknown document corpus without any prior knowledge about it.

Research efforts have attempted to provide the model selection capability to the above methods. One proposal, X-means <10>, is an extension of K-means with an added functionality of estimating the number of clusters to generate. The Baysian Information Criterion (BIC) is employed to determine whether to split a cluster or not. The splitting is conducted when the information gain for splitting a cluster is greater than the gain for keeping that cluster.

On the other hand, hierarchical clustering methods cluster a document corpus into a hierarchical tree structure with one cluster at its root encompassing all the documents. The most commonly used method in this category is the hierarchical agglomerative clustering (HAC) <4, 13> which starts by placing each document into a distinct cluster. Pair-wise similarities between all the clusters are computed and the two closest clusters are then merged into a new cluster. This process of computing pair-wise similarities and merging the closest two clusters is repeated until all the documents are merged into one cluster.

There are many variations of the HAC which mainly differ in the ways used to compute the similarity between clusters. Typical similarity computations include single-linkage, complete-linkage, group-average linkage, as well as other aggregate measures. The single-linkage, and the complete-linkage use the maximum, and the minimum distances between the two clusters, respectively, while the group-average uses the distance of the cluster centers, to define the similarity of the two clusters. Research studies have also investigated different types of similarity metrics and their impacts on clustering accuracy <8>.

In contrast to the HAC method and its variations, there are hierarchical clustering methods that use the annealed EM algorithm to extract hierarchical relations within the document corpus <9>. The key idea is the introduction of a temperature T. which is used as a control parameter that is initialized at a high value and successively lowered until the performance on the held-out data starts to decrease. Since annealing leads through a sequence of so-called phase transitions where clusters obtained in the previous iteration further split, it generates a hierarchical tree structure for the given document set. Unlike the HAC method, leaf nodes in this tree structure do not necessarily correspond to individual documents.

### OBJECTIVES AND BRIEF SUMMARY OF THE INVENTION

To overcome the aforementioned problems and limitations, a document partitioning (flat clustering) method is provided.

An objective of the document clustering method is to achieve a high document clustering accuracy.

Another objective of the document clustering method is to provide a high precision model selection capability.

The document clustering method is autonomous, unsupervised, and performs document clustering without the requirement of domain-dependent background information, nor predefined document categories or a given list of topics. It achieves a high document clustering accuracy in the following manner. First, a richer feature set is employed to represent each document. For document retrieval and clustering purposes, a document is typically represented by a term-frequency vector with its dimensions equal to the number of unique words in the corpus, and each of its components indicating how many times a particular word occurs in the document. However, experimental study shows that document clustering based on term-frequency vectors often yields poor performances because not all the words in the documents are discriminative or characteristic words. An investigation of various data corpora also shows that documents belonging to the same topic/event usually share many name entities, such as names of people, organizations, locations, etc., and contain many similar word associations. For example, among the documents reporting the Clinton-Lewinsky scandal, “Clinton”, “Lewinsky”, “Ken Starr”, “Linda Tripp”, etc., are the most common name entities, and “grand jury”, “independent counsel”, “supreme court” are the word pairs that most frequently appear. Based on these observations, each document is represented using a richer feature set that includes the frequencies of salient name identities and word-pairs, as well as all the unique terms. In an exemplary and non-limiting embodiment, using this feature set, initial document clustering is conducted based on the Gaussian Mixture Model (GMM) and the Expectation-Maximization (EM) algorithm. This clustering process generates a set of document clusters with a local maximum-likelihood. Maximum-likelihood means that the generated document clusters are most likely clusters given the document corpus. However, the GMM+EM algorithm guarantees only a local maximum solution, and there is no guarantee that the document clusters generated by this algorithm is the globally optimal solution.

To further improve the document clustering accuracy, a group of discriminative features is determined from the initial clustering result, and then the document clusters are refined based on the majority vote using this discriminative feature set. A major deficiency of the above GMM+EM clustering method, as well as many other clustering methods, is that they treat all the features in a feature set equally, some of which are discriminative while others are not. In many document corpora, it is often the case that discriminative words (features) occur less frequently than non-discriminative words. When the feature vector of a document is dominated by non-discriminative features, clustering the document using the above methods may result in a misplacement of the document.

To determine whether a word is discriminative or not, a discriminative feature metric (DFM) is introduced which compares, for example, the word's occurrence frequency inside a cluster against that outside the cluster. If a word has the highest occurrence frequency inside cluster i and has a low occurrence frequency outside that cluster, this word is highly discriminative for cluster i. Using this exemplary DFM, a set of discriminative features is identified, each of which is associated with a particular cluster. This discriminative feature set is then used to vote on the cluster label of each document. Assume that the document dⱼ contains λ discriminative features, and that the largest number of the λ features are associated with cluster i, then document dⱼ is voted to belong to cluster i. By voting on the cluster labels for all the documents, a refined document clustering result is obtained. This process of determining discriminative features, and re-fining the clusters using the majority vote is repeated until the clustering result converges, in other words, until the difference in the clustering results from the different iterations becomes small enough. Through this self-refinement process, the correctness of the whole cluster set is gradually improved, and eventually, documents in the corpus are accurately grouped according to their topics/main contents.

To achieve the model selection capability, a value C is assumed for the number of clusters N comprising the data corpus. Using any clustering method, document clustering is conducted several times by randomly selecting C initial clusters, and the degree of disparity in the clustering results is observed. Then these operations are repeated for different values of N, and the value Cₘᵢₙ of N that yields the minimum disparity in the clustering results is selected. The basic idea here is that, if the assumption as to the number of clusters is correct, each repetition of the clustering process will produce similar sets of document clusters; otherwise, clustering results obtained from each repetition will be unstable, showing a large disparity.

### BRIEF DESCRIPTION OF THE DRAWING FIGURES

Features and advantages of the present invention will become apparent to those skilled in the art from the following description with reference to the drawings, in which:

FIG. 1 illustrates an exemplary voting scheme for refining document clusters.

FIG. 2 illustrates an exemplary model selection algorithm.

### DETAILED DESCRIPTION OF THE PREFERRED EMBODIMENTS

The Invention

The following subsections provide the detailed descriptions of the main operations comprising the document clustering method.

A. Feature Set

For purposes of illustration, the following three kinds of features are used to represent each document dᵢ.

Term frequencies (TF): Let W={w₁, w₂, . . . , wᵣ} be the complete vocabulary set of the document corpus after the stop-words removal and words stemming operations. The term-frequency vector tᵢ of document dᵢ is defined as

tᵢ={tƒ(w₁, dᵢ), tƒ(w₂, dᵢ), . . . , tƒ(w_{Γ}, dᵢ)} (1)

where t ƒ(wₓ, d_{y}) denotes the term frequency of word wₓ∈W in document d_{y}.

Name entities (NE): Name entities, which include names of people, organizations, locations, etc., are detected using a support vector machine-based classifier <12>, and the tagged Brown corpus <1> is used for training examples to train the classifier. Once the name entities are detected, their occurrence frequencies within the document corpus are computed, and those name entities which have very low occurrence values are discarded. Let E={e₁, e₂, . . . , e_{Δ}) be the complete set of name entities whose occurrence values are above the predefined threshold Tₑ. The name-entity vector eᵢ of document dᵢ is defined as

eᵢ={oƒ(e₁, dᵢ), oƒ(e₂, dᵢ), . . . , oƒ(e_{Δ, d}ᵢ)} (2)

where oƒ(eₓ, d_{y}) denotes the occurrence frequency of name entity eₓ∈E in document d_{y}.

Term pairs (TP): If the document corpus has a large vocabulary set, then the number of possible term associations will become unacceptably large. To make the feature set compact, only those term associations which have statistical significance for the document corpus are considered. The χ² distribution metric φ(wₓ, w_{y})² defined below <7> is used to measure the statistical significance for the association of terms wₓ and w_{y}.

$${φ ( {w}_{x} , {w}_{y} )}^{2} = \frac{{( ad - bc )}^{2}}{( a + b ) ( a + c ) ( b + d ) ( c + d )} \qquad ( 3 )$$

where α=freq(wₓ, w_{y}), b=freq(\overline{w}ₓ, w_{y}), c=freq(wₓ, \overline{w}_{y}), and d=freq(\overline{w}ₓ, \overline{w}_{y}) denote the number of sentences in the whole document corpus that contain both wₓ, w_{y}; w_{y} but no wₓ; wₓ but no w_{y}; and no wₓ, w_{y}; respectively. Let A be the ordered set of term associations whose χ² distribution metric φ(wₓ, w_{y})² are above the predefined threshold Tₐ:

A={(wₓ, w_{y})|wₓ∈W; w_{y}∈W; φ(wₓ, w_{y})>Tₐ}. The term-pair vector aᵢ of document dᵢ is defined as

aᵢ={count(wₓ, w_{y})|(wₓ, w_{y})∈A} (4)

where count(wₓ, w_{y}) denotes the number of sentences in document dᵢ that contains both wₓ and w_{y}.

With the above feature vectors tᵢ, eᵢ, and aᵢ, the complete feature vector dᵢ for document dᵢ is formed as: dᵢ={tᵢ, eᵢ, aᵢ}.

Text clustering tasks are well known for their high dimensionality. The document feature vector dᵢ created above has nearly one thousand dimensions. To reduce the possible over-fitting problem, the singular value decomposition (SVD) is applied to the whole set of document feature vectors D={d₁, d₂, . . . , d_{N}}, and the twenty dimensions which have the largest singular values are selected to form the clustering feature space. Using this reduced feature space, document clustering is conducted using, for example, the Gaussian Mixture Model together with the EM algorithm to obtain the preliminary clusters for the document corpus.

B. Gaussian Mixture Model

The Gaussian Mixture Model (GMM) for document clustering assumes that each document vector d is generated from a model Θ that consists of the known number of clusters cᵢ where i=1, 2, . ., k.

$$P ( d \vert Θ ) = {\sum }_{i = 1}^{k} P ( {c}_{i} ) P ( d \vert {c}_{i} ) \qquad ( 5 )$$

Every cluster cᵢ is a m-dimensional Gaussian distribution which contributes to the document vector d independent of other clusters:

$$P ( d \vert {c}_{i} ) = \frac{1}{{( 2 π )}^{\frac{m}{2}} {\vert {\sum }_{i} \vert}^{\frac{1}{2}}} exp ( - 1 / 2 {( d - {μ}_{i} )}^{T} {\sum }_{i}^{- 1} ( d - {μ}_{i} ) ) \qquad ( 6 )$$

With this GMM formulation, the clustering task becomes the problem of fitting the model Θ given a set of N document vectors D. Model Θ is uniquely determined by the set of centroids μᵢ's and covariance matrices Σᵢ's. The Expectation-Maximization(EM) algorithm <6> is a well established algorithm that produces the maximum-likelihood solution of the model.

With the Gaussian components, the two steps in one iteration of the EM algorithm are as follows:

E-step: re-estimates the expectations based on the previous iteration

$$\begin{matrix}P ( {c}_{i} \vert {d}_{j} ) = \frac{{P ( {c}_{i} )}^{old} P ( {d}_{j} \vert {c}_{i} )}{{\sum }_{i = 1}^{k} {P ( {c}_{i} )}^{old} P ( {d}_{j} \vert {c}_{i} )} & ( 7 ) \\ {P ( {c}_{i} )}^{new} = \frac{1}{N} {\sum }_{j = 1}^{N} P ( {c}_{i} \vert {d}_{j} ) & ( 8 )\end{matrix}$$

M-step: updates the model parameters to maximize the log-likelihood

$$\begin{matrix}{μ}_{i} = \frac{{\sum }_{j = 1}^{N} P ( {c}_{i} \vert {d}_{j} ) {d}_{j}}{{\sum }_{j = 1}^{N} P ( {c}_{i} \vert {d}_{j} )} & ( 9 ) \\ {\sum }_{i} = \frac{{\sum }_{j = 1}^{N} P ( {c}_{i} \vert {d}_{j} ) ( {d}_{j} - {μ}_{i} ) {( {d}_{j} - {μ}_{i} )}^{T}}{{\sum }_{j = 1}^{N} P ( {c}_{i} \vert {d}_{j} )} & ( 10 )\end{matrix}$$

In the above illustrative implementation of the GMM+EM algorithm, the initial set of centroids μᵢ's are randomly chosen from a normal distribution with the mean

$${μ}_{0} = \frac{1}{N} {\sum }_{i} {d}_{i}$$

and the covariance matrix

$${\sum }_{0} = \frac{1}{N} {\sum }_{i} ( {d}_{i} - {μ}_{0} ) {( {d}_{i} - {μ}_{0} )}^{T} .$$

The initial set of covariance matrices of Σᵢ's are identically set to Σ₀. The log-likelihood that the data corpus is generated from the model Θ, L(D|Θ), is utilized as the termination condition for the iterative process. The EM iteration is terminated when L(D|Θ) comes to convergence.

The above approach to initializing centroids μᵢ's and covariance matrices Σᵢ's enables the random picking up of an initial set of clusters for each repetition of the document clustering process, and plays a significant role in achieving the model selection capability, as discussed more fully below.

After the model Θ has been estimated, the cluster label lᵢ of each document dᵢ can be determined as

$${l}_{i} = arg { max}_{j} p ( {d}_{i} \vert {c}_{j} ) .$$

C. Refining Clusters by Feature Voting

The above GMM+EM clustering method generates an initial set of clusters for a given document corpus. Because the GMM+EM clustering method treats all the features equally, when the feature vector of a document is dominated by non-discriminative features, the document might be misplaced into a wrong cluster. To further improve the document clustering accuracy, a group of discriminative features is determined from the initial clustering result, and then the document clusters are iteratively refined using this discriminative feature set.

To determine whether a feature ƒᵢ is discriminative or not, an exemplary and non-limiting discriminative feature metric DFM(ƒᵢ) is defined as follows,

$$DFM ( {f}_{i} ) = log \frac{{g}_{i n} ( {f}_{i} )}{{g}_{out} ( {f}_{i} )} \qquad ( 11 )$$

gᵢₙ(ƒᵢ)=max(g(ƒᵢ,c₁),g(ƒᵢ,c₂), . . . , g(ƒᵢ,cₖ)) (12)

$${g}_{out} ( {f}_{i} ) = \frac{{\sum }_{j} g ( {f}_{i} , {c}_{j} ) - {g}_{i n} ( {f}_{i} )}{k - 1} \qquad ( 13 )$$

where g(ƒᵢ, cⱼ) denotes the number of occurrences of feature ƒᵢ in cluster cⱼ, and k denotes the total number of document clusters. For the purpose of document clustering, discriminative features are those that occur more frequently inside a particular cluster than outside that cluster, whereas non-discriminative features are those that have similar occurrence frequencies among all the clusters. What the metric DFM(ƒᵢ) reflects is exactly this disparity in occurrence frequencies of feature ƒᵢ among different clusters. In other words, the more discriminative the feature ƒᵢ, the larger value the metric DFM(ƒᵢ) takes. In an illustrative embodiment, discriminative features are defined as those whose DFM values exceed the predefined threshold T_{df}.

When the discriminative feature ƒᵢ has the highest occurrence frequency in cluster cₓ, it is determined that ƒᵢ is discriminative for cₓ, and the cluster label x for ƒᵢ (denoted as σᵢ) is saved for the later feature voting operation. By definition, σᵢ can be expressed as:

$${σ}_{i} = arg {max}_{x} g ( {f}_{i} , {c}_{x} ) \qquad ( 14 )$$

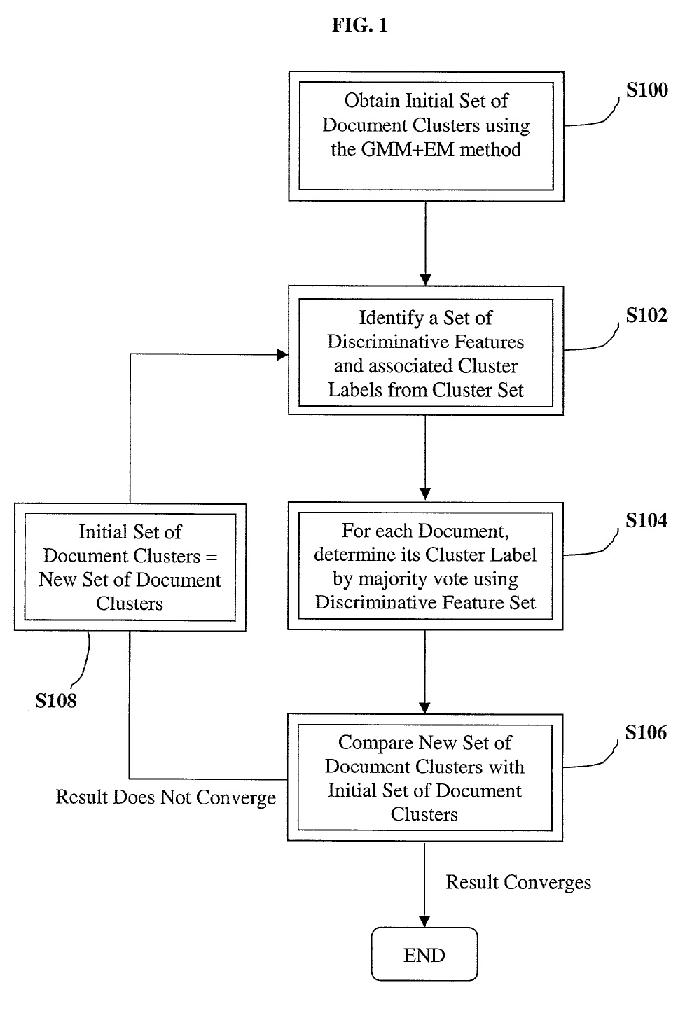

Once the set of discriminative features has been identified, an iterative voting scheme is applied to refine the document clusters. FIG. 1 illustrates an exemplary iterative voting scheme.

Step 1. Obtain the initial set of document clusters C={c₁, c₂, . . . , cₖ} using the GMM+EM method. (S100)

Step 2. From the cluster set C, identify the set of discriminative features F={ƒ₁,ƒ₂, . . . , ƒ_{Λ}} along with their associated cluster labels S={σ₁, σ₂, . . . , σ_{Λ}}. (S102)

Step 3. For each document dⱼ in the whole document corpus, determine its cluster label lⱼ by the majority vote using the discriminative feature set. (S104)

Assume that the document dⱼ contains a subset of discriminative features F^{(j)}=}ƒ₁^{(j)},ƒ₂^{(j)}, . . . , ƒ_{λ}^{(j)}}⊂F, and that the cluster labels associated with this subset F^{(j)} are S^{(j)}={σᵢ^{(j)}, σ₂^{(j)}, . . . , σ_{λ}^{(j)}}. Then, the new cluster label for document dⱼ is determined as

$${l}_{j}^{new} = arg {max}_{{σ}_{y} ∈ {S}^{( j )}} cnt ( {σ}_{y} , {S}^{( j )} ) \qquad ( 15 )$$

where cnt(σ_{y}, S^{(j)}) denotes the number of times the label σ_{y} occurs in S^{(j)}.

Step 4. Compare the new document cluster set with C. (S106) If the result converges (i.e. the difference is sufficiently small), terminate the process; otherwise, set C to the new cluster set (S108), and return to Step 2.

The above iterative voting process is a self-refinement process. It starts with an initial set of document clusters with a relatively low accuracy. From this initial clustering result, the process strives to find features that are discriminative for each cluster, and then refine the clusters by voting on the cluster label of each document using these discriminative features. Through this self-refinement process, the correctness of the whole cluster set is gradually improved, and eventually, documents in the corpus are accurately grouped according to their topics/main contents.

D. Model Selection

The approach for realizing the model selection capability is based on the hypothesis that, if solutions (i.e. correct document clusters) are sought in an incorrect solution space (i.e. using an incorrect number of clusters), the results obtained from each run of the document clustering will be quite randomized because the solution does not exist. Otherwise, the results obtained from multiple runs must be very similar assuming that there is only one genuine solution in the solution space. Translating this into the model selection problem, it can be said that, if the assumption of the number of clusters is correct, each run of the document clustering will produce similar sets of document clusters; otherwise, clustering result obtained from each run will be unstable, showing a large disparity.

For purposes of illustration, to measure the similarity between the two sets of document clusters C={c₁,c₂, . . . , cₖ} and C′={c₁′,c₂′, . . . , cₖ′}, the following mutual information metric MI(C, C′) is used:

$$MI ( C , C ) = {\sum }_{{c}_{i} ∈ C , {c}_{j}^{′} ∈ {C}^{′}} p ( {c}_{i} , {c}_{j}^{′} ) \cdot {log}_{2} \frac{p ( {c}_{i} , {c}_{j}^{′} )}{p ( {c}_{i} ) \cdot p ( {c}_{j}^{′} )} \qquad ( 16 )$$

here p(cᵢ), p(cⱼ′) denote the probabilities that a document arbitrarily selected from the corpus belongs to the clusters cᵢ and cⱼ′, respectively, and p(cᵢ, cⱼ′) denotes the joint probability that this arbitrarily selected document belongs to the clusters cᵢ and cⱼ′ at the same time. MI(C, C′) takes values between zero and max(H(C),H(C′)), where H(C) and H(C′) are the entropies of C and C′, respectively. It reaches the maximum max(H(C),H(C′)) when the two sets of document clusters are identical, whereas it becomes zero when the two sets are completely independent. Another important character of MI(C, C′) is that, for each cᵢ∈C, it does not need to find the corresponding counterpart in C′, and the value stays the same for all kinds of permutations.

To simplify comparisons between different cluster set pairs, the following normalized metric \hat{M}I(C,C′) which takes values between zero and one is used:

$$\hat{M} I ( C , {C}^{′} ) = \frac{MI ( C , {C}^{′} )}{max ( H ( C ) , H ( {C}^{′} ) )} \qquad ( 17 )$$

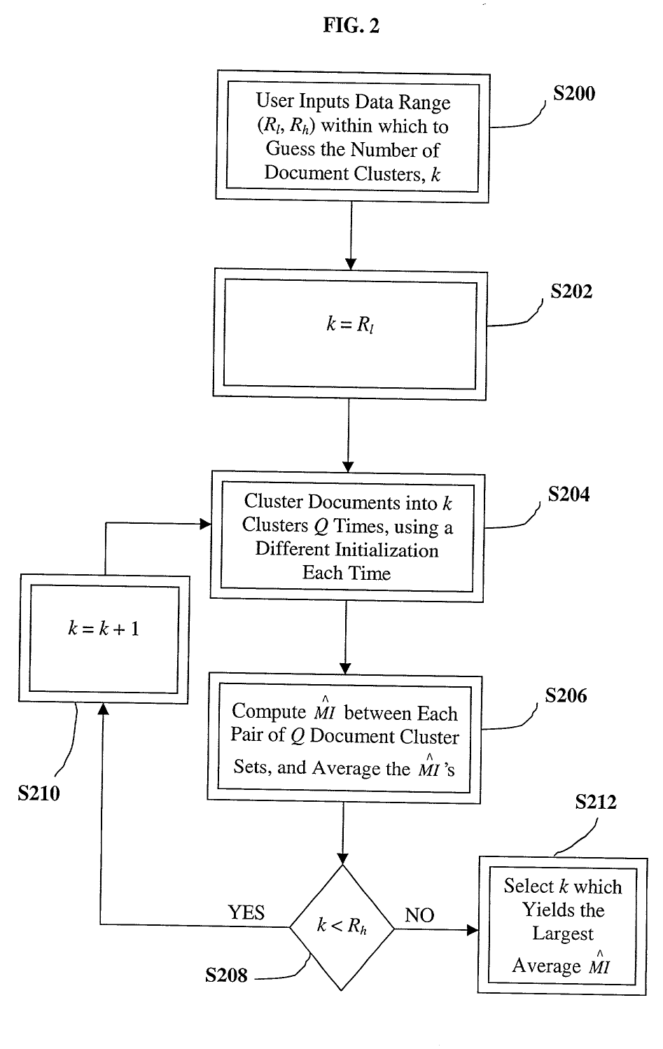

FIG. 2 illustrates an exemplary model selection algorithm:

Step 1. Get the user's input for the data range (Rₗ, Rₕ) within which to guess the possible number of document clusters. (S200)

Step 2. Set k=Rₗ. (S202)

Step 3. Cluster the document corpus into k clusters, and run the clustering process with different cluster initializations for Q times. (S204)

Step 4. Compute \hat{M}I between each pair of the results, and take the average on all the \hat{M}I's. (S206)

Step 5. If k<Rₕ (S208), k=k+1 (S210) and return to Step 3.

Step 6. Select the k which yields the largest average \hat{M}I. (S212)

Experimental Evaluations

An evaluation database was constructed using the National Institute of Standards and Technology's (NIST) Topic Detection and Tracking (TDT2) corpus <2>. The TDT2 corpus is composed of documents from six news agencies, and contains 100 major news events reported in 1998. Each document in the corpus has a unique label that indicates which news event it belongs to. From this corpus, 15 news events reported by three news agencies including CNN, ABC, and VOA were selected. Table 1 provides detailed statistics of our evaluation database.

TABLE 1
Selected topics from the TDT2 Corpus

| | | No. of Docs | | | | Max sents/ | Min sents/ | Avg sents/ |
|---|---|---|---|---|---|---|---|---|
| Event ID | Event Subject | ABC | CNN | VOA | Total | doc | doc | doc |
| 01 | Asian Economic Crisis | 27 | 90 | 289 | 406 | 86 | 1 | 12 |
| 02 | Monica Lewinsky Case | 102 | 497 | 96 | 695 | 157 | 1 | 12 |
| 13 | 1998 Winter Olympics | 21 | 81 | 108 | 210 | 47 | 1 | 11 |
| 15 | Current Conflict with Iraq | 77 | 438 | 345 | 860 | 73 | 1 | 12 |
| 18 | Bombing AL Clinic | 9 | 73 | 5 | 87 | 29 | 2 | 8 |
| 23 | Violence in Algeria | 1 | 1 | 60 | 62 | 42 | 1 | 9 |
| 32 | Sgt. Gene McKinney | 6 | 91 | 3 | 100 | 32 | 2 | 7 |
| 39 | India Parliamentary Elections | 1 | 1 | 29 | 31 | 45 | 2 | 15 |
| 44 | National Tobacco Settlement | 26 | 163 | 17 | 206 | 52 | 2 | 9 |
| 48 | Jonesboro shooting | 13 | 73 | 15 | 101 | 79 | 2 | 16 |
| 70 | India, A Nuclear Power? | 24 | 98 | 129 | 251 | 54 | 2 | 12 |
| 71 | Israeli-Palestinian Talks (London) | 5 | 62 | 48 | 115 | 33 | 2 | 9 |
| 76 | Anti-Suharto Violence | 13 | 55 | 114 | 182 | 44 | 1 | 11 |
| 77 | Unabomber | 9 | 66 | 6 | 81 | 37 | 2 | 10 |
| 86 | GM Strike | 14 | 83 | 24 | 121 | 37 | 2 | 8 |

A. Document Clustering Evaluation

The testing data used for evaluating the document clustering method were formed by mixing documents from multiple topics arbitrarily selected from the evaluation database. At each run of the test, documents from a selected number k of topics are mixed, and the mixed document set, along with the cluster number k, are provided to the clustering process. The result is evaluated by comparing the cluster label of each document with its label provided by the TDT2 corpus.

Two illustrative metrics, the accuracy (AC) and the \hat{M}I defined by Equation (17), are used to measure the document clustering performance. Given a document dᵢ, let lᵢ and αᵢ be the cluster label and the label provided by the TDT2 corpus, respectively. The AC is defined as follows:

$$AC = \frac{{\sum }_{i = 1}^{N} δ ( {α}_{i} , map ( {l}_{i} ) )}{N} \qquad ( 18 )$$

where N denotes the total number of documents in the test, δ(x, y) is the delta function that equals one if x=y and equals zero otherwise, and map(lᵢ) is the mapping function that maps each cluster label lᵢ to the equivalent label from the TDT2 corpus. Computing AC is time consuming because there are k! possible corresponding relationships between k cluster labels lᵢ and TDT2 labels αᵢ, and all these k! relationships would have to be tested in order to discover a genuine one. In contrast to AC, metric \hat{M}I is easy to compute because it does not require the knowledge of corresponding relationships, and provides an alternative for measuring the document clustering accuracy.

Table 2 shows the results comprising 15 runs of the test. Labels in the first column denote how the corresponding test data are constructed. For example, label “ABC-01-02-15” means that the test data is composed of events 01, 02, and 15 reported by ABC, and “ABC+CNN-01-13-18-32-48-70-71-77-86” denotes that the test data is composed of events 01, 13, 18, 32, 48, 70, 71, 77 and 86 from both ABC and CNN. To understand how the three kinds of features as well as the cluster refinement process contribute to the document clustering accuracy, document clustering using only the GMM+EM method was conducted under the following four different feature combinations: TF only, TF+NE, TF+TP, and TF+NE+TP. Note that the GMM+EM method using TF only is a close representation of traditional probabilistic document clustering methods <3, 11>, and therefore, its performance can be used as a benchmark for measuring the improvements achieved by the proposed method.

TABLE 2
Evaluation Results for Document Clustering

| | GMM + EM | | | | | | | | GMM + EM + | |
|---|---|---|---|---|---|---|---|---|---|---|
| | TF | | TF + NE | | TF + TP | | TF + NE + TP | | Refinement | |
| Test Data | AC | MI | AC | MI | AC | MI | AC | MI | AC | MI |
| ABC-01-02-15 | 0.8571 | 0.6579 | 0.8132 | 0.5554 | 0.5055 | 0.3635 | 0.9011 | 0.7832 | 1.0000 | 1.0000 |
| ABC-02-15-44 | 0.6829 | 0.4474 | 0.9122 | 0.6936 | 0.8195 | 0.6183 | 0.9659 | 0.8559 | 0.9002 | 0.9444 |
| ABC-01-13-44-70 | 0.6531 | 0.6770 | 0.7653 | 0.6427 | 0.8673 | 0.7177 | 0.7449 | 0.6286 | 1.0000 | 1.0000 |
| ABC-01-44-48-70 | 0.8111 | 0.7124 | 0.8444 | 0.7328 | 0.7111 | 0.6234 | 0.8000 | 0.6334 | 1.0000 | 1.0000 |
| CNN-01-02-15 | 0.9688 | 0.8445 | 0.9707 | 0.8546 | 0.9678 | 0.8440 | 0.9795 | 0.8848 | 0.9756 | 0.9008 |
| CNN-02-15-44 | 0.9791 | 0.8896 | 0.9827 | 0.9086 | 0.9791 | 0.8903 | 0.9927 | 0.9547 | 0.9964 | 0.9742 |
| CNN-02-74-76 | 0.8931 | 0.3266 | 0.9946 | 0.9012 | 0.9909 | 0.8476 | 0.9982 | 0.9602 | 1.0000 | 1.0000 |
| VOA-01-02-15 | 0.7292 | 0.5106 | 0.8646 | 0.6611 | 0.7812 | 0.5923 | 0.8438 | 0.6250 | 0.9896 | 0.9571 |
| VOA-01-13-76 | 0.7396 | 0.4663 | 0.9179 | 0.8608 | 0.7500 | 0.4772 | 0.9479 | 0.8608 | 0.9583 | 0.8619 |
| VOA-01-23-70-76 | 0.7422 | 0.5582 | 0.9219 | 0.8196 | 0.8359 | 0.6558 | 0.9297 | 0.8321 | 0.9453 | 0.8671 |
| VOA-12-39-48-71 | 0.6939 | 0.5039 | 0.8673 | 0.7643 | 0.6429 | 0.4878 | 0.8061 | 0.8237 | 0.9898 | 0.9692 |
| VOA-44-18-70-71-76-77-86 | 0.6459 | 0.6465 | 0.7535 | 0.7338 | 0.5751 | 0.6521 | 0.7734 | 0.7539 | 0.8527 | 0.7720 |
| ABC + CNN-01-13-18- | 0.9420 | 0.8977 | 0.9716 | 0.9390 | 0.8343 | 0.8671 | 0.9633 | 0.9209 | 0.9704 | 0.9351 |
| 32-48-70-71-77-86 | | | | | | | | | | |
| CNN + VOA-01-13- | 0.6985 | 0.6729 | 0.9339 | 0.8890 | 0.8939 | 0.8159 | 0.9431 | 0.9044 | 0.9262 | 0.8854 |
| 48-70-71-76-77-86 | | | | | | | | | | |
| ABC + CNN + VOA-44- | 0.7454 | 0.7321 | 0.7721 | 0.8297 | 0.8871 | 0.8401 | 0.8768 | 0.9189 | 0.9938 | 0.9807 |
| 48-70-71-76-77-86 | | | | | | | | | | |

The outcomes can be summarized as follows. With the GMM+EM method itself, using TF, TF+NE, and TF+TP produced similar document clustering performances, while using all three kinds of features generated the best performance. Regardless of the above feature combinations, results generated by using the GMM+EM in tandem with the cluster refinement process are always superior to the results generated by using the GMM+EM alone. Performance improvements made by the cluster refinement process become very obvious when the GMM+EM method generates poor clustering results. For example, for the test data “VOA-12-39-48-71” (row 11), the GMM+EM method using TF alone produced a document clustering accuracy of 0.6939. Using all three kinds of features with the GMM+EM method increased the accuracy to 0.8061, a 16% improvement. Performning the cluster refinement process in tandem with the exemplary GMM+EM method further improved the accuracy to 0.9898, an additional 23% improvement.

B. Model Selection Evaluation

Performance evaluations for the model selection are conducted in a similar fashion to the document clustering evaluations. At each run of the test, documents from a selected number k of topics are mixed, and the mixed document set is provided to the model selection algorithm. This time, instead of providing the number k, the algorithm outputs its guess at the number of topics contained in the test data. Table 3 presents the results of 12 runs.

TABLE 3
Evaluation Results for Model Selection

| Test Data | Proposed | BIC-based |
|---|---|---|
| ABC-01-03 | ∘ 2 | x 1 |
| ABC-01-02-15 | ∘ 3 | x 2 |
| ABC-02-48-70 | x 2 | x 2 |
| ABC-44-70-01-13 | ∘ 4 | x 2 |
| ABC-44-48-70-76 | ∘ 4 | x 3 |
| CNN-01-02-15 | x 4 | x 26 |
| CNN-01-02-13-15-18 | ∘ 5 | x 17 |
| CNN-44-48-70-71-76-77 | x 5 | x 23 |
| VOA-01-02-15 | ∘ 3 | ∘ 3 |
| VOA-01-13-76 | ∘ 3 | ∘ 3 |
| VOA-01-23-70-76 | ∘ 4 | ∘ 4 |
| VOA-12-39-48-71 | ∘ 4 | ∘ 4 |

∘, x indicate correct, wrong answers, respectively.

For comparison, the BIC-based model selection method <10>was also implemented, and its performances evaluated using the same test data. Evaluation results generated by the two methods are displayed side by side in Table 3. Clearly, the proposed method remarkably outperforms the BIC-based method: among the 12 runs of the test, the former made nine correct guesses while the latter made only four correct ones.

This great performance gap comes from the different hypotheses adopted by the two methods. The BIC-based method is based on the naive hypothesis that a simpler model is a better model, and hence, it gives penalties to the choices of more complicated solutions. Obviously, this hypothesis may not be true for all real-world problems, especially for clustering document corpora with complicated internal structures. In contrast, the present method is based on the hypothesis that searching for the solution in a wrong solution space yields randomized results, and therefore, it prefers solutions that are consistent and stable. The superior performance of the present method suggests that its underlying hypothesis provides a better description of the real-world problems, especially for document clustering applications.

Conclusion

The above-described document clustering method achieves a high accuracy of document clustering and provides the model selection capability. To accurately cluster the given document corpus, a richer feature set is used to represent each document, and the GMM Model is used together with the EM algorithm, as an illustrative and non-limiting approach, to conduct the initial document clustering. From this initial result, a set of discriminative features is identified for each cluster, and this feature set is used to refine the document clusters based on a majority voting scheme. The discriminative feature identification and cluster refinement operations are applied iteratively until the convergence of document clusters. On the other hand, the model selection capability is achieved by guessing a value C for the number of clusters N, conducting the document clustering several times by randomly selecting C initial clusters, and observing the degree of disparity in the clustering results. The experimental evaluations, discussed above, not only establish the effectiveness of the document clustering method, but also demonstrate how each feature as well as the cluster refinement process contributes to the document clustering accuracy.

The above description of the preferred embodiments, including any references to the accompanying figures, was intended to illustrate a specific manner in which the invention may be practiced. However, it is to be understood that other embodiments may be utilized and changes may be made without departing from the scope of the present invention.

For example and not by way of limitation, a computer program product including a computer-readable medium could employ the aforementioned document clustering method. One knowledgeable in computer systems will appreciate that “media”, or “computer-readable media”, as used here, may include a diskette, a tape, a compact disc, an integrated circuit, a cartridge, a remote transmission via a communications circuit, or any other similar medium useable by computers. For example, to supply software that defines a process, the supplier might provide a diskette or might transmit the software in some fonn via satellite transmission, via a direct telephone link, or via the Internet.

There is claimed:

1. A method for clustering a plurality of documents into a specified number of clusters, comprising the steps of:
(a) using a set of features to represent each document;
(b) generating a set of the specified number of document clusters from the plurality of documents using a Gaussian Mixture Model and an Expectation-Maximization algorithm and said set of features.

2. The method of claim 1, wherein said set of features comprises at least two of the following: a frequency of one or more names within the document, a frequency of one or more word pairs within the document, and a frequency of one or more unique terms within the document.

3. The method of claim 1, wherein said set of features comprises at least two of the following: a frequency of one or more names within the document, a frequency of one or more word pairs within the document, and a frequency of all unique terms within the document.

4. The method of claim 1, wherein said set of features comprises a frequency of one or more names within the document, a frequency of one or more word pairs within the document, and a frequency of one or more unique terms within the document.

5. The method of claim 1, wherein the Expectation-Maximization algorithm is repeated until a log-likelihood of said plurality of documents is generated from a model comes to a convergence, and wherein the model consists of the known number of clusters.

6. A method for clustering a plurality of documents into a specified number of clusters, comprising the steps of:
(a) using a set of features to represent each document; and
(b) generating the specified number of document clusters from the plurality of documents using any method of document clustering and said set of features;
wherein said set of features comprises at least two of the following: a frequency of one or more names within the document, a frequency of one or more word pairs within the document, and a frequency of all unique terms within the document.

7. A method for clustering a plurality of documents into a specified number of clusters, comprising the steps of:
(a) using a set of features to represent each document; and
(b) generating the specified number of document clusters from the plurality of documents using any method of document clustering and said set of features;
wherein said set of features comprises a frequency of one or more names within the document, a frequency of one or more word pairs within the document, and a frequency of one or more unique terms within the document.

8. A method for refining a document clustering accuracy, comprising the steps of:
(a) obtaining a current set of a specified number of document clusters for a plurality of documents;
(b) determining a set of discriminative features from the current set of document clusters;
(c) refining the current set of document clusters using the set of discriminative features; and
(d) repeating steps (b) and (c) until a predetermined measure of the document clustering accuracy is achieved.

9. The method of claim 8, wherein a discriminative feature is any feature useful in accurately clustering a plurality of documents.

10. The method of claim 8, wherein a feature is discriminative if it occurs more frequently inside a particular cluster than outside the cluster.

11. The method of claim 8, wherein the step of refining the document clusters using the set of discriminative features comprises:
(c1) identifying a set of cluster labels associated with the set of discriminative features;
(c2) obtaining a new document cluster set by determining the cluster label for each document using a majority vote by the discriminative feature set;
(c3) comparing the new document cluster set with the current set of document clusters, and
when the result converges, terminating the refinement of document clustering, otherwise setting the current set of document clusters to the new document cluster set, and returning to the step of determining a set of discriminative features from the current set of document clusters.

12. A method for refining a document clustering accuracy, comprising the steps of:
(a) obtaining a current set of a specified number of document clusters for a plurality of documents;
(b) determining a set of discriminative features from the current set of document clusters;
(c) performing a document clustering using the set of discriminative features to obtain a refined set of the specified number of document clusters;
(d) computing a change between the current set of document clusters and the refined set of document clusters, and when the change is below a predefined threshold, terminating the process, otherwise setting the refined set of document clusters as the current set of document clusters and returning to step (b).

13. The method of claim 12, wherein said step of obtaining a current set of document clusters for a plurality of documents comprises the following steps:
(a1) using a set of features to represent each document;
(a2) generating said current set of the specified number of document clusters from said plurality of documents, using a Gaussian Mixture Model and an Expectation-Maximization algorithm and said set of features.

14. A method for determining a number of clusters in an unknown data corpus, comprising the ordered steps of:
(a) obtaining from a user, an input range within which to guess a number of document clusters;
(b) guessing the number of document clusters is the lowest value of the input range;
(c) clustering the documents into the guessed number of document clusters;
(d) repeating step (c) with a different cluster initialization for a specified number of times;
(e) measuring a similarity between each pair of generated document cluster sets;
(f) when the guessed number of document clusters is less than the maximum value of the input range, incrementing the guessed number of document clusters by one, and returning to step (c); and
(g) when the guessed number of document clusters equals the maximum value of the input range, selecting the guessed number of document clusters that yielded the greatest measured similarity between generated document cluster sets.

15. The method of claim 14, wherein said step of measuring a similarity between each pair of generated document cluster sets, further comprises averaging all the measurements.

16. The method of claim 14, wherein said step of clustering the documents into the guessed number of document clusters comprises:
(c1) using a set of features to represent each document;
(c2) generating the guessed number of document clusters, using a Gaussian Mixture Model and an Expectation-Maximization algorithm and said set of features.

17. The method of claim 14, wherein said step of measuring a similarity between each pair of generated document cluster sets involves the use of any metric that measures the similarity between two cluster sets.

18. The method of claim 14, wherein said step of measuring a similarity between each pair of generated document cluster sets involves the use of a normalized metric \hat{M}I(C,C′), which takes values between zero and one and is defined as:
$$\hat{M} I ( C , {C}^{′} ) = \frac{MI ( C , {C}^{′} )}{max ( H ( C ) , H ( {C}^{′} ) )}$$
wherein C and C′ represent a pair of generated document cluster sets;
wherein
$$MI ( C , C ) = {\sum }_{{c}_{i} ∈ C , {c}_{j}^{′} ∈ {C}^{′}} p ( {c}_{i} , {c}_{j}^{′} ) \cdot {log}_{2} \frac{p ( {c}_{i} , {c}_{j}^{′} )}{p ( {c}_{i} ) \cdot p ( {c}_{j}^{′} )} ;$$
wherein p(cᵢ) and p(cⱼ′) denote the probabilities that a document arbitrarily selected from the data corpus belongs to the clusters cᵢ and cⱼ′, respectively, and p(cᵢ, cⱼ) denotes the joint probability that this arbitrarily selected document belongs to the clusters cᵢ and Cⱼ′ at the same time; and wherein H(C) and H(C′) are the entropies of C and C′, respectively.

19. A computer program product for enabling a computer to cluster a plurality of documents into a specified number of clusters, comprising:
software instructions for enabling the computer to perform predetermined operations, and
a computer readable medium bearing the software instructions;
wherein the predetermined operations include the steps of:
(a) using a set of features to represent each document; and
(b) generating a set of a specified number of document clusters using a Gaussian Mixture Model and an Expectation-Maximization algorithm and said set of features.

20. A computer program product for enabling a computer to refine a document clustering accuracy, comprising:
software instructions for enabling the computer to perform predetermined operations, and
a computer readable medium bearing the software instructions;
wherein the predetermined operations include the steps of:
(a) obtaining a current set of a specified number of document clusters for a plurality of documents;
(b) determining a set of discriminative features from the current set of document clusters;
(c) refining the current set of document clusters using the set of discriminative features; and
(d) repeating steps (b) and (c) until a predetermined measure of the document clustering accuracy is achieved.

21. A computer program product for determining a number of clusters in an unknown data corpus, comprising:
software instructions for enabling the computer to perform predetermined operations, and
a computer readable medium bearing the software instructions;
wherein the predetermined operations include the ordered steps of:
(a) obtaining from a user, an input range within which to guess the number of clusters;
(b) guessing the number of clusters is the lowest value of the input range;
(c) clustering the data corpus into a set of the guessed number of document clusters;
(d) repeating step (c) with a different cluster initialization for a specified number of times;
(e) measuring a similarity between each pair of generated document cluster sets;
(f) when the guessed number of document clusters is less than the maximum value of the input range, incrementing the guessed number of document clusters by one, and returning to step (c); and
(g) when the guessed number of document clusters equals the maximum value of the input range, selecting the guessed number of document clusters that yielded the greatest measured similarity between generated document cluster sets.
